(19) United States
(12) Patent Application Publication
(10) Pub. No.: US 2013/0176758 A1
(43) Pub. Date: Jul. 11, 2013

(54) MOSFET BRIDGE RECTIFIER

(71) Applicant: Richtek Technology Corporation, Chupei City (TW)

(72) Inventors: Pei-Kai TSENG, Keelung City (TW); Jyun-Che HO, Xikou Township (TW); Chien-Fu TANG, Hsinchu City (TW); Isaac Y. CHEN, Jubei City (TW)

(73) Assignee: RICHTEK TECHNOLOGY CORPORATION, Chupei City (TW)

(21) Appl. No.: 13/735,652

(22) Filed: Jan. 7, 2013

(30) Foreign Application Priority Data
Jan. 9, 2012 (TW) 101100830

(51) Int. Cl. H02M 7/219

(52) U.S. Cl. CPC H02M 7/219
USPC 363/89

(57) ABSTRACT

A bridge rectifier is established by MOSFETs instead of diodes. The MOSFET bridge rectifier includes a voltage detector to detect the voltages of two AC input terminals of the MOSFET bridge rectifier, for identifying the positive and negative half cycles of an AC voltage input to the MOSFET bridge rectifier, thereby accurately controlling the MOSFETs.

### FIELD OF THE INVENTION

The present invention is related generally to a rectifier circuit and, more particularly, to a MOSFET bridge rectifier.

### BACKGROUND OF THE INVENTION

Bridge rectifier type devices typically use diodes to convert alternating-current (AC) waveform to direct-current (DC) waveform. For example, as shown in FIG. 1, four diodes D1, D2, D3 and D4 are used to establish a bridge rectifier 10 to rectify an AC voltage VACIN into a DC voltage VIN for a power factor correction (PFC) power converter 12. Under heavy load condition the power loss is significant and thus makes the system low efficiency because a diode has about 0.6V forward voltage drop. For example, assuming that the peak current flowing through the diodes D1, D2, D3 and D4 shown in FIG. 1 is 0.2 A, a conductive diode will have a power loss of about 0.076 W.

U.S. Pat. No. 7,411,768 and U.S. Pat. Publication No. 2009/0257259 replace the diodes in a bridge rectifier with MOSFETs to reduce the power loss of the bridge rectifier because a MOSFET typically has an on-resistance of the mΩ scale. Assuming that the on-resistance of a MOSFET is 1Ω and the peak current flowing therethrough is 0.2 A, a MOSFET bridge rectifier will have a power loss of about 0.02 W. Therefore, replacement of diodes with MOSFETs can reduce power loss and give the system a better efficiency. However, the existing MOSFET bridge rectifiers must use high-voltage PMOSFETs at the high side of the circuit, as shown in U.S. Pat. No. 7,411,768 and U.S. Pat. Publication No. 2009/0257259, and thus require higher costs.

In addition, for a MOSFET bridge rectifier, it is necessary to identify the positive and negative half cycles of the AC voltage VACIN for switching the MOSFETs. Therefore, it also needs a circuit to accurately switch the MOSFETs.

### SUMMARY OF THE INVENTION

An objective of the present invention is to provide a MOSFET bridge rectifier.

Another objective of the present invention is to provide a MOSFET bridge rectifier capable of accurately switching the MOSFETs thereof.

Yet another objective of the present invention is to provide a bridge rectifier using NMOSFETs at its high side.

According to the present invention, a bridge rectifier includes a first MOSFET connected between a first AC input terminal and a DC output terminal, a second MOSFET connected between the first AC input terminal and a ground terminal, a third MOSFET connected between a second AC input terminal and the DC output terminal, a fourth MOSFET connected between the second AC input terminal and the ground terminal, a voltage detector to detect a first voltage of the first AC input terminal and a second voltage of the second AC input terminal to assert a first detection signal when the first voltage is greater than a first preset value and a second detection signal when the second voltage is greater than a second preset value, and a floating gate driver to control the first and fourth MOSFETs according to the first detection signal, and the second and third MOSFETs according to the second detection signal. The floating gate driver provides high voltages as the first and third control signals, and thus the first and third MOSFETs at the high side may be NMOSFETs to reduce costs.

According to the present invention, a bridge rectifier includes a first MOSFET connected between a first AC input terminal and a DC output terminal and controlled by a first control signal, a second MOSFET connected between the first AC input terminal and a ground terminal and controlled by a second control signal, a third MOSFET connected between a second AC input terminal and the DC output terminal and controlled by a third control signal, a fourth MOSFET connected between the second AC input terminal and the ground terminal and controlled by a fourth control signal, a voltage detector to detect a first voltage of the first AC input terminal and a second voltage of the second AC input terminal to generate the second and fourth control signals, and a level shifter to shift the second and fourth control signals to generate the first and third control signals. When the first voltage is greater than a first preset value, the first and fourth MOSFETs are on, and when the second voltage is greater than a second preset value, the second and third MOSFETs are on.

A bridge rectifier according to the present invention is established by MOSFETs instead of diodes, and thus can provide a better efficiency. Moreover, the positive and negative half cycles of an AC voltage are identified by detecting the voltages at the first and second AC input terminals, and thus the MOSFETs can be controlled accurately.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a circuit diagram of a conventional bridge rectifier for a PFC power converter;

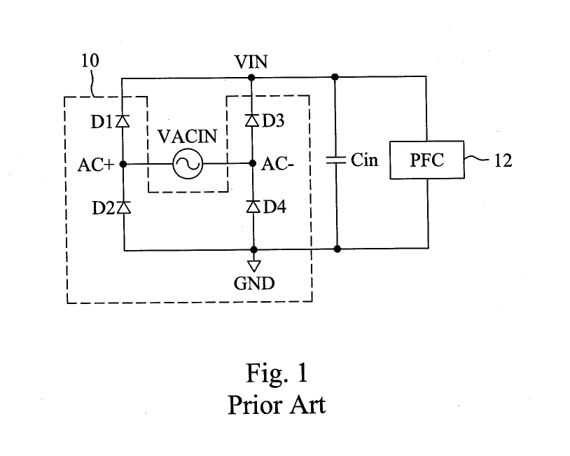

FIG. 2 is a circuit diagram of a first embodiment according to the present invention;

FIG. 3 is a waveform diagram of the circuit shown in FIG. 2;

FIG. 4 is a circuit diagram of an embodiment for the high-side floating circuit and the level shifter shown in FIG. 2;

FIG. 5 is a circuit diagram of a second embodiment for the voltage detector shown in FIG. 2;

FIG. 6 is a circuit diagram of a third embodiment for the voltage detector shown in FIG. 2; and

FIG. 7 is a circuit diagram of a second embodiment according to the present invention.

### DETAILED DESCRIPTION OF THE INVENTION

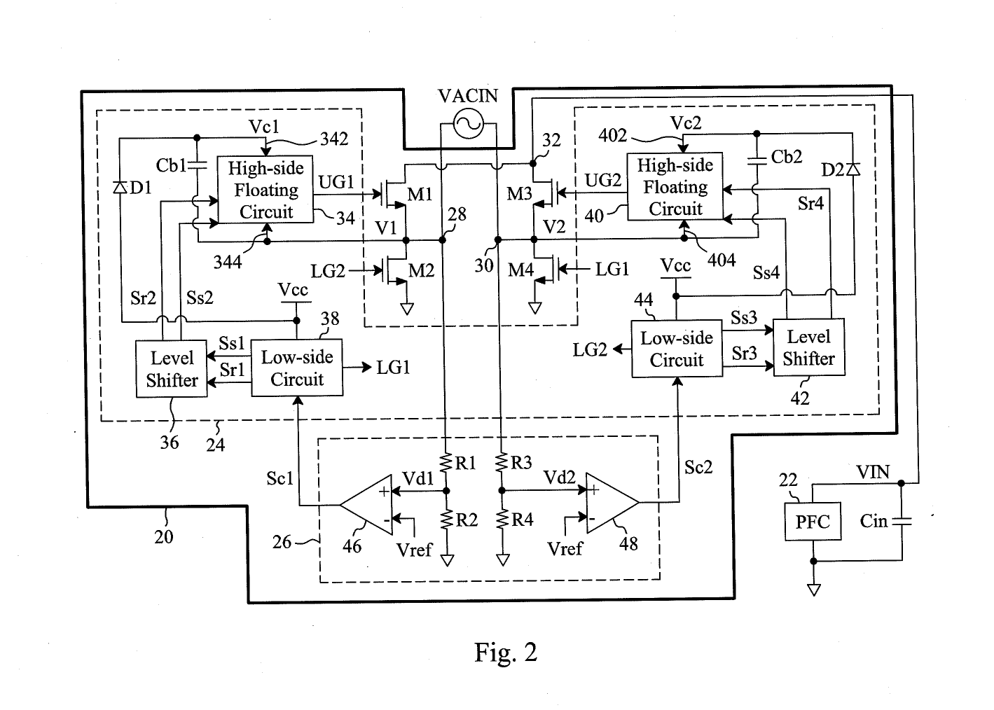

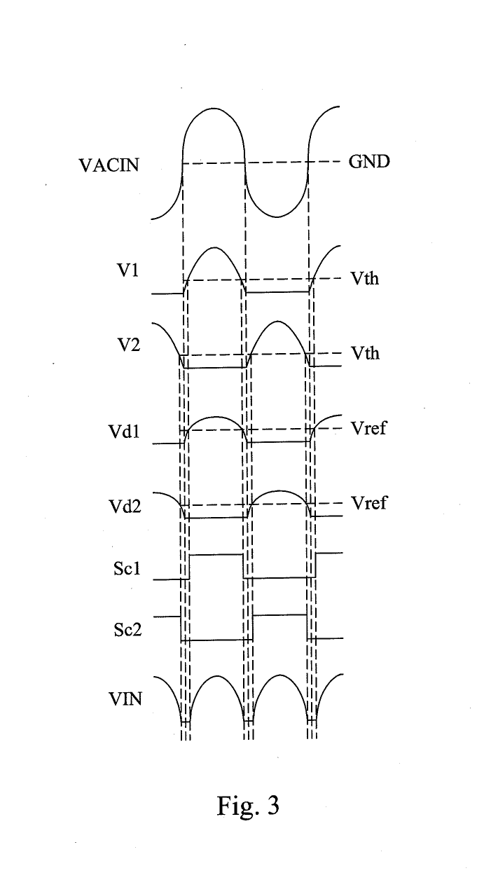

As shown in FIG. 2, a MOSFET bridge rectifier 20 according to the present invention includes AC input terminals 28 and 30 to be connected to an AC voltage source VACIN, a DC output terminal 32 to be connected to a load, for example, a PFC power converter 22, NMOSFETs M1, M2, M3 and M4, a floating gate driver 24, and a voltage detector 26. The NMOSFET M1 is connected between the DC output terminal 32 and the AC input terminal 28 and is controlled by a control signal UG1, the NMOSFET M2 is connected between the AC input terminal 28 and a ground terminal GND and is controlled by a control signal LG2, the NMOSFET M3 is connected between the DC output terminal 32 and the AC input terminal 30 and is controlled by a control signal UG2, and the NMOSFET M4 is connected between the AC input terminal 30 and the ground terminal GND and is controlled by a control signal LG1. The voltage detector 26 detects the voltages V1 and V2 at the AC input terminals 28 and 30 to generate detection signals Sc1 and Sc2, respectively, and the floating gate driver 24 generates the control signals UG1 and LG1 according to the detection signal Sc1, and the control signals UG2 and LG2 according to the detection signal Sc2. The control signals UG1, LG2, UG2 and LG1 are used to switch the NMOSFETs M1, M2, M3 and M4, respectively, to convert the AC voltage VACIN into a DC voltage VIN for the PFC power converter 22. As shown by the waveforms in FIG. 3, when the voltage V1 at the AC input terminal 28 is greater than a preset value Vth, the voltage detector 26 asserts the detection signal Sc1, so the floating gate driver 24 turns on the NMOSFETs M1 and M4 in response thereto; when the voltage V2 at the AC input terminal d 30 is greater than the preset value Vth, the voltage detector 26 asserts the detection signal Sc2, so the floating gate driver 24 turns on the NMOSFETs M2 and M3 in response thereto. In the embodiment shown in FIG. 2, the MOSFET bridge rectifier 20 uses the floating gate driver 24 to provide the high-voltage control signals UG1 and UG2, and thus allows the use of the NMOSFETs M1 and M3 at the high side of the circuit to reduce costs.

The floating gate driver 24 shown in FIG. 2 includes high-side floating circuits 34 and 40, level shifters 36 and 42, low-side circuits 38 and 44, capacitors Cb1 and Cb2, and diodes D1 and D2. The diode D1 is connected between a power source voltage terminal Vcc and a power source input terminal 342 of the high-side floating circuit 34, and the diode D2 is connected between the power source voltage terminal Vcc and a power source input terminal 402 of the high-side floating circuit 40. The capacitor Cb1 is connected between the AC input terminal 28 and the power source input terminal 342 of the high-side floating circuit 34, for making the voltage Vc1 vary with the voltage V1, and the capacitor Cb2 is connected between the AC input terminal 30 and the power source input terminal 402 of the high-side floating circuit 40, for making the voltage Vc2 vary with the voltage V2. The low-side circuit 38 generates the control signal LG1, a setting signal Ss1 and a resetting signal Sr1 according to the detection signal Sc1, the level shifter 36 shifts the setting signal Ss1 and the resetting signal Sr1 to generate a setting signal Ss2 and a resetting signal Sr2, respectively, and the high-side floating circuit 34 determines the control signal UG1 according to the setting signal Ss2 and the resetting signal Sr2. The power source input terminals 342 and 344 of the high-side floating circuit 34 receive the voltages Vc1 and V1, respectively, so that the output control signal UG1 can drive the NMOSFET M1. The low-side circuit 44 generates the control signal LG2, a setting signal Ss3 and a resetting signal Sr3 according to the detection signal Sc2, the level shifter 42 shifts the setting signal Ss3 and the resetting signal Sr3 to generate a setting signal Ss4 and a resetting signal Sr4, respectively, and the high-side floating circuit 40 determines the control signal UG2 according to the setting signal Ss4 and the resetting signal Sr4. The power source input terminals 402 and 404 of the high-side floating circuit 40 receive the voltages Vc2 and V2, respectively, so that the output control signal UG2 can drive the NMOSFET M3.

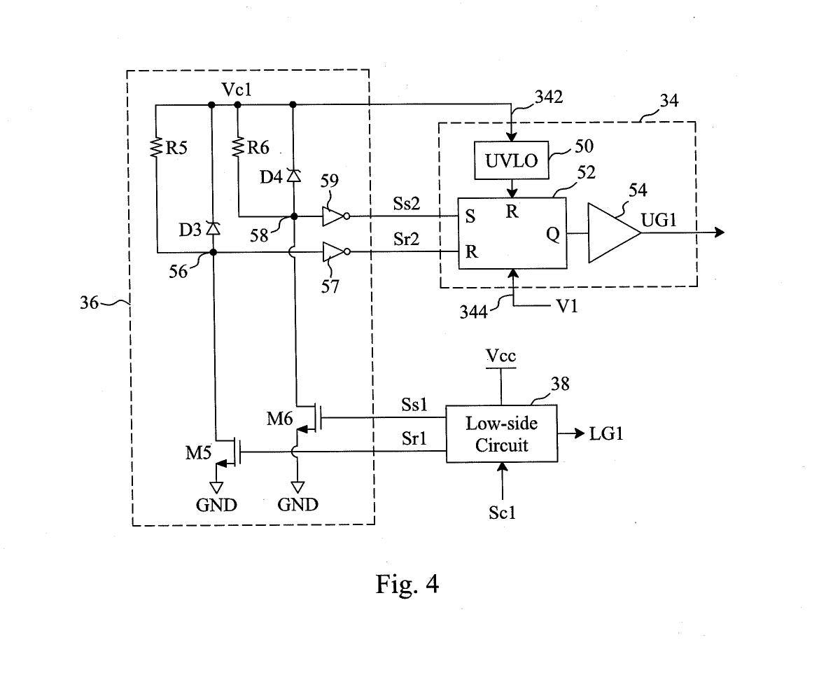

FIG. 4 is an embodiment for the high-side floating circuit 34 and the level shifter 36 shown in FIG. 2. In this embodiment, the high-side floating circuit 34 includes an under voltage lock out (UVLO) circuit 50, an SR flip-flop 52 and a driver 54. The SR flip-flop 52 determines its output signal Q according to the setting signal Ss2 and the resetting signal Sr2, and the driver 54 generates the control signal UG1 according to the signal Q. The UVLO circuit 50 detects the voltage Vcl, and turns off the SR flip-flop 52 when the voltage Vc1 is lower than a predetermined threshold value. The level shifter 36 includes resistors R5 and R6, diodes D3 and D4, switches M5 and M6, and inverters 57 and 59. The resistor R5 is connected between the voltage terminal Vc1 and a node 56, the diode D3 is connected in parallel to the resistor R5 to clamp the voltage at the node 56, the switch M5 is connected between the node 56 and the ground terminal GND, and the inverter 57 is connected between the node 56 and the reset input R of the SR flip-flop 52 to generate the resetting signal Sr2 according to the voltage at the node 56. The resistor R6 is connected between the voltage terminal Vc1 and a node 58, the diode D4 is connected in parallel to the resistor R6 to clamp the voltage at the node 58, the switch M6 is connected between the node 58 and the ground terminal GND, and the inverter 59 is connected between the node 58 and the set input S of the SR flip-flop 52 to generate the setting signal Ss2 according to the voltage at the node 56. The switches M5 and M6 are controlled by the resetting signal Sr1 and the setting signal Ss1, respectively, provided by the low-side circuit 38. When the switch M5 is on and the switch M6 is off, the voltage at the node 56 is at a low level, so the resetting signal Sr2 is at a high level, and the voltage at the node 58 is at a high level, so the setting signal Ss2 is at a low level, causing the high-side floating circuit 34 to turn off the control signal UG1. When the switch M5 is off and the switch M6 is on, the voltage at the node 56 is high, so the resetting signal Sr2 is low, and the voltage at the node 58 is low, so the setting signal Ss2 is high, causing the high-side floating circuit 34 to trigger the control signal UG1. The high-side floating circuit 40 and the level shifter 42 shown in FIG. 2 are structurally identical to the high-side floating circuits 34 and the level shifter 36 shown in FIG. 4.

Although the embodiments illustrated in FIGS. 2 and 4 use common floating gate drivers for examples, other floating gate drivers having different configuration therefrom, such as those disclosed in U.S. Pat. Nos. 5,552,731 and 7,236,020, may be used.

In the embodiment shown in FIG. 2, the voltage detector 26 includes resistors R1, R2, R3 and R4, and comparators 46 and 48. The resistors R1 and R2 are connected in series between the AC input terminal 28 and the ground terminal GND to divide the voltage V1 of the AC input terminal 28 to generate a voltage Vd1, for the comparator 46 to compare with a reference voltage Vref to generate the detection signal Sc1. The resistors R3 and R4 are connected in series between the AC input terminal 30 and the ground terminal GND to divide the voltage V2 of the AC input terminal 30 to generate a voltage Vd2, for the comparator 48 to compare with the reference voltage Vref to generate the detection signal Sc2. As shown by the waveforms in FIG. 3, a voltage Vd1 greater than the reference voltage Vref indicates that the voltage V1 is greater than the preset value Vth, so the comparator 46 asserts the detection signal Sc1; a voltage Vd2 greater than reference voltage Vref indicates that the voltage V2 is greater than the preset value Vth, so the comparator 48 asserts the detection signal Sc2.

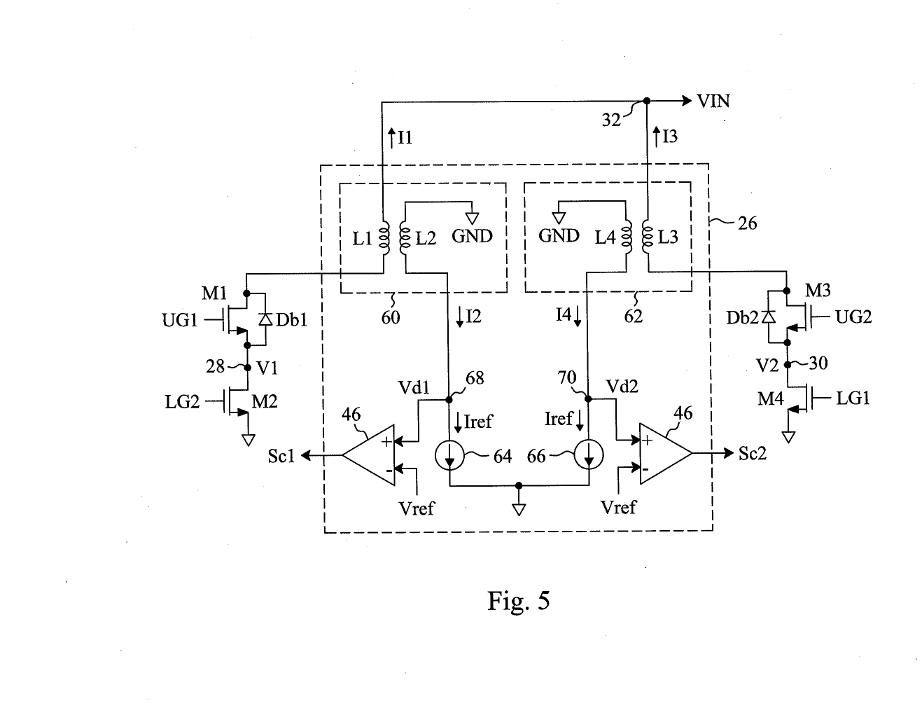

FIG. 5 is a second embodiment for the voltage detector 26 shown in FIG. 2, which identifies the voltages at the AC input terminals 28 and 30 by detecting the currents I1 and I3 of the NMOSFETs M1 and M3 to determine the detection signals Sc1 and Sc2, respectively. In this embodiment, the voltage detector 26 includes current sensors 60 and 62, comparators 46 and 48, and current sources 64 and 66. The current sensors 60 and 62 sense the currents I1 and I3 of the NMOSFETs M1 and M3 to generate current sense signals I2 and I4, respectively, and each of the current sources 64 and 66 provides a constant current Iref. When the voltage V1 of the AC input terminal 28 increases, a body diode Db1 of the NMOSFET M1 is on and thus a current I1 flows to the DC output terminal 32 from the AC input terminal 28 through the body diode Db1. The current I1 and the current sense signal I2 increase with an increase of the voltage V1. When the current sense signal I2 becomes greater than the current Iref, the voltage Vd1 at the node 68 increases. When the voltage Vd1 is greater than the reference voltage Vref, the comparator 46 asserts the detection signal Sc1. When the voltage V2 of the AC input terminal 30 increases, a body diode Db2 of the NMOSFET M3 is on and thus a current I3 flows to the DC output terminal 32 from the AC input terminal 30 through the body diode Db2. The current I3 and the current sense signal I4 increase with an increase of the voltage V2. When the current sense signal I4 becomes greater than the current Iref, the voltage Vd2 at the node 70 increases. When the voltage Vd2 is greater than the reference voltage Vref, the comparator 48 asserts the detection signal Sc2. The current sensor 60 includes inductors L1 and L2. The inductor L1 is connected in series to the NMOSFET M1, so the current of the inductor L1 is equal to the current I1 of the NMOSFET M1. The inductor L2 senses the current I1 of the inductor L1 to generate the current sense signal I2. The current sensor 62 includes inductors L3 and L4. The inductor L3 is connected in series to the NMOSFET M3, so the current of the inductor L3 is equal to the current I3 of the NMOSFET M3. The inductor L4 senses the current I3 of the inductor L3 to generate the current sense signal I4.

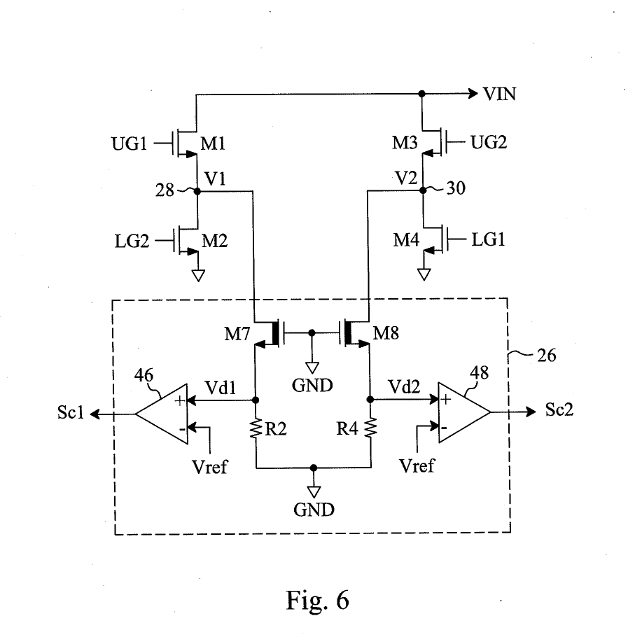

FIG. 6 is a third embodiment for the voltage detector 26 shown in FIG. 2, in which the roles of the resistors R1 and R3 shown in FIG. 2 are replaced by gate-grounded depletion-type NMOSFETs M7 and M8. When the voltages V1 and V2 are zero, the depletion-type NMOSFETs M7 and M8 are on. When the voltage V1 of the AC input terminal 28 increases, the source voltage Vd1 of the depletion-type NMOSFET M7 increases accordingly. When the voltage Vd1 reaches the threshold voltage of the depletion-type NMOSFET M7, the depletion-type NMOSFET M7 is turned off, thereby limiting the maximum value of the voltage Vd1, to prevent a high voltage from applying the voltage detector 26. When the voltage Vd1 is greater than the reference voltage Vref, the comparator 46 asserts the detection signal Sc1. Likewise, when the voltage V2 of the AC input terminal 30 increases, the voltage Vd2 increases accordingly. When the voltage Vd2 reaches the threshold voltage of the depletion-type NMOSFET M8, the depletion-type NMOSFET M8 is turned off, thereby limiting the maximum value of the voltage Vd2. When the voltage Vd2 is greater than the reference voltage Vref, the comparator 48 asserts the detection signal Sc2. In this embodiment, the resistors R2 and R4 act as current limiting resistors.

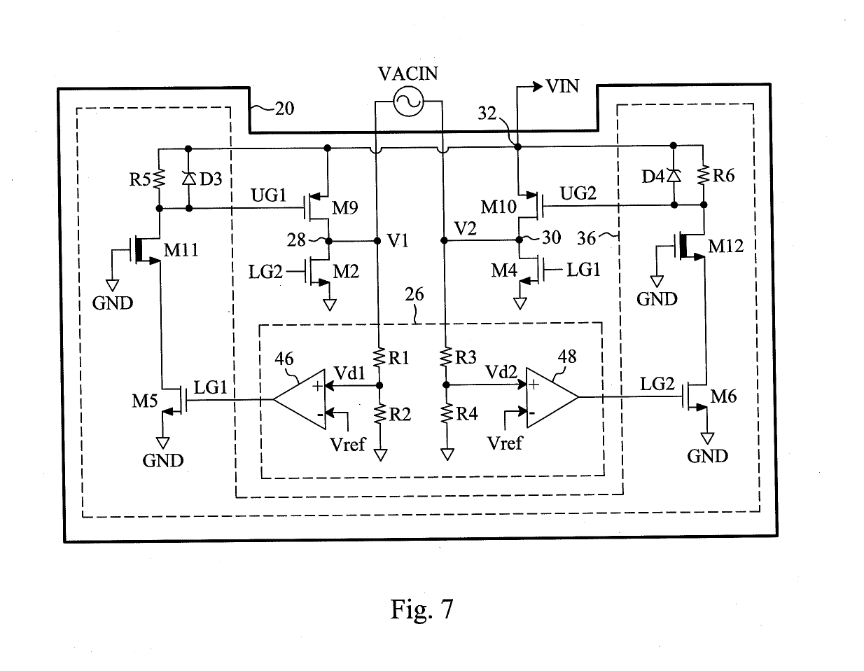

FIG. 7 is a second embodiment of a MOSFET bridge rectifier 20 according to the present invention, which includes NMOSFETs M2 and M4, PMOSFETs M9 and M10, a voltage detector 26 and a level shifter 36. The PMOSFET M9 is connected between the DC output terminal 32 and the AC input terminal 28, the NMOSFET M2 is connected between the AC input terminal 28 and the ground terminal GND, the PMOSFET M10 is connected between the DC output terminal 32 and the AC input terminal 30, and the NMOSFET M4 is connected between the AC input terminal 30 and the ground terminal GND. The voltage detector 26 detects the voltages V1 and V2 of the AC input terminals 28 and 30 to generate the control signals LG1 and LG2 for controlling the NMOSFETs M4 and M2, respectively, and the level shifter 36 shifts the control signals LG1 and LG2 to generate the control signals UG1 and UG2 for controlling the PMOSFETs M9 and M10, respectively.

In the embodiment shown in FIG. 7, the voltage detector 26 includes resistors R1, R2, R3 and R4, and comparators 46 and 48. The resistors R1 and R2 are connected in series between the AC input terminal 28 and the ground terminal GND to divide the voltage V1 to generate the voltage Vd1, for the comparator 46 to compare with the reference voltage Vref to generate the control signal LG1. The resistors R3 and R4 are connected in series between the AC input terminal 30 and the ground terminal GND to divide the voltage V2 to generate the voltage Vd2, for the comparator 48 to compare with the reference voltage Vref to generate the control signal LG2. The voltage detector 26 shown in FIG. 7 may be modified into the voltage detector shown in FIG. 6.

In the embodiment shown in FIG. 7, the level shifter 36 includes resistors R5 and R6, diodes D3 and D4, switches M5 and M6, and depletion-type NMOSFETs M11 and M12. The resistor R5 and the diode D3 are connected in parallel between the DC output terminal 32 and the gate of the PMOSFET M9, the resistors R6 and the diode D4 are connected in parallel between the DC output terminal 32 and the gate of the PMOSFET M10, the depletion-type MOSFET M11 is connected between the gate of the PMOSFET M9 and the switch M5, and the depletion-type MOSFET M12 is connected between the gate of the PMOSFET M10 and the switch M6. The depletion-type MOSFETs M11 and M12 are used to block high voltages, to thereby prevent the voltage drop across the switches M5 and M6 from being excessively high. As shown in FIG. 3, when the voltage V1 is greater than the preset value Vth, the voltage Vd1 is greater than the reference voltage Vref, thus the comparator 46 asserts the control signal LG1 to turn on the NMOSFET M4, and also turn on the switch M5 to have the control signal UG1 transited to a low level to turn on the PMOSFET M9; when the voltage V2 is greater than the preset value Vth, the voltage Vd2 is greater than the reference voltage Vref, so the control signal LG2 turns on the NMOSFET M2 and the switch M6, and the control signal UG2 transits to low to turn on the PMOSFET M10.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A MOSFET bridge rectifier comprising:
a first AC input terminal and a second AC input terminal, receiving an AC voltage;
a DC output terminal providing a DC voltage;
a first MOSFET connected between the first AC input terminal and the DC output terminal;
a second MOSFET connected between the first AC input terminal and a ground terminal;
a third MOSFET connected between the second AC input terminal and the DC output terminal;
a fourth MOSFET connected between the second AC input terminal and the ground terminal;
a voltage detector connected to the first and second AC input terminals, detecting a first voltage of the first AC input terminal and a second voltage of the second AC input terminal to assert a first detection signal when the first voltage is greater than a first preset value and assert a second detection signal when the second voltage is greater than a second preset value; and
a floating gate driver connected to the voltage detector and the first through fourth MOSFETs, switching the first through fourth MOSFETs according to the first and second detection signals.

2. The MOSFET bridge rectifier of claim 1, wherein each of the first and third MOSFETs is an NMOSFET.

3. The MOSFET bridge rectifier of claim 1, wherein the voltage detector comprises:
a first pair of resistors serially connected to the first AC input terminal, dividing the first voltage to generate a third voltage;
a first comparator connected to the first pair of resistors, comparing the third voltage with a first reference voltage to generate the first detection signal;
a second pair of resistors serially connected to the second AC input terminal, dividing the second voltage to generate a fourth voltage; and
a second comparator connected to the second pair of resistors, comparing the fourth voltage with a second reference voltage to generate the second detection signal.

4. The MOSFET bridge rectifier of claim 1, wherein the voltage detector comprises:
a first comparator comparing a third voltage related to the first voltage with a first reference voltage to generate the first detection signal; and
a first current sensor connected to the first comparator, sensing a current of the first MOSFET to generate a first current sense signal to determine the third voltage;
a second comparator comparing a fourth voltage related to the second voltage with a second reference voltage to generate the second detection signal; and
a second current sensor connected to the second comparator, sensing a current of the third MOSFET to generate a second current sense signal to determine the fourth voltage.

5. The MOSFET bridge rectifier of claim 4, wherein the first current sensor comprises:
a first inductor connected in series to the first MOSFET; and
a second inductor inductively coupled to the first inductor, induced by the first inductor to generate the first current sense signal.

6. The MOSFET bridge rectifier of claim 4, wherein the second current sensor comprises:
a first inductor connected in series to the third MOSFET; and
a second inductor inductively coupled to the first inductor, induced by the first inductor to generate the second current sense signal.

7. The MOSFET bridge rectifier of claim 1, wherein the voltage detector comprises:
a first depletion-type MOSFET connected to the first AC input terminal, receiving the first voltage to generate a third voltage and limiting an maximum value of the third voltage; and
a first comparator connected to the first depletion-type MOSFET, comparing the third voltage with a first reference voltage to generate the first detection signal;
a second depletion-type MOSFET connected to the second AC input terminal, receiving the second voltage to generate a fourth voltage and limiting an maximum value of the fourth voltage; and
a second comparator connected to the second depletion-type MOSFET, comparing the fourth voltage with a second reference voltage to generate the second detection signal.

8. The MOSFET bridge rectifier of claim 1, wherein the floating gate driver comprises:
a first high-side floating circuit having a first power source input terminal and a second power source input terminal, the second power source input terminal being connected to the first AC input terminal, the first high-side floating circuit providing a first control signal for controlling the first MOSFET;
a first capacitor connected between the first AC input terminal and the first power source input terminal;
a first low-side circuit connected to the voltage detector, generating a first setting signal, a first resetting signal and a second control signal for controlling the fourth MOSFET according to the first detection signal;
a first level shifter connected to the first high-side floating circuit and the first low-side circuit, shifting the first setting signal and the first resetting signal to generate a second setting signal and a second resetting signal for the first high-side floating circuit, thereby determining the first control signal;
a second high-side floating circuit having a third power source input terminal and a fourth power source input terminal, the fourth power source input terminal being connected to the second AC input terminal, the second high-side floating circuit providing a third control signal for controlling the third MOSFET;
a second capacitor connected between the second AC input terminal and the third power source input terminal;
a second low-side circuit connected to the voltage detector, generating a third setting signal, a third resetting signal and a fourth control signal for controlling the second MOSFET according to the second detection signal; and
a second level shifter connected to the second high-side floating circuit and the second low-side circuit, shifting the third setting signal and the third resetting signal to generate a fourth setting signal and a fourth resetting signal for the second high-side floating circuit, thereby determining the third control signal.

9. A MOSFET bridge rectifier comprising:
a first AC input terminal and a second AC input terminal, receiving an AC voltage;
a DC output terminal providing a DC voltage;
a first MOSFET connected between the first AC input terminal and the DC output terminal, controlled by a first control signal;
a second MOSFET connected between the first AC input terminal and a ground terminal, controlled by a second control signal;
a third MOSFET connected between the second AC input terminal and the DC output terminal, controlled by a third control signal;
a fourth MOSFET connected between the second AC input terminal and the ground terminal, controlled by a fourth control signal;
a voltage detector connected to the first and second AC input terminals, detecting a first voltage of the first AC input terminal and a second voltage of the second AC input terminal to assert the second and fourth control signals; and
a level shifter connected to the first and third MOSFETs and the voltage detector, shifting the second and fourth control signals to generate the first and third control signals;
wherein when the first voltage is greater than a first preset value, the first and fourth MOSFETs are on, and when the second voltage is greater than a second preset value, the second and third MOSFETs are on.

10. The MOSFET bridge rectifier of claim 9, wherein each of the first and third MOSFETs is a PMOSFET.

11. The MOSFET bridge rectifier of claim 9, wherein the voltage detector comprises:
a first pair of resistors serially connected to the first AC input terminal, dividing the first voltage to generate a third voltage;
a first comparator connected to the first pair of resistors, comparing the third voltage with a first reference voltage to generate the fourth control signal;
a second pair of resistors serially connected to the second AC input terminal, dividing the second voltage to generate a fourth voltage; and
a second comparator connected to the second pair of resistor, comparing the fourth voltage with a second reference voltage to generate the second control signal.

12. The MOSFET bridge rectifier of claim 9, wherein the voltage detector comprises:
a first depletion-type MOSFET connected to the first AC input terminal, receiving the first voltage to generate a third voltage and limiting an maximum value of the third voltage;
a first comparator connected to the first depletion-type MOSFET, comparing the third voltage with a first reference voltage to generate the fourth control signal;
a second depletion-type MOSFET connected to the second AC input terminal, receiving the second voltage to generate a fourth voltage and limiting an maximum value of the fourth voltage; and
a second comparator connected to the second depletion-type MOSFET, comparing the fourth voltage with a second reference voltage to generate the second control signal.

13. The MOSFET bridge rectifier of claim 9, wherein the level shifter comprises:
a first resistor connected between the DC output terminal and a gate of the first MOSFET;
a first diode connected in parallel to the first resistor, clamping a voltage drop of the first resistor;
a first switch switched by the fourth control signal to determine the first control signal;
a first depletion-type MOSFET connected between the gate of the first MOSFET and the first switch, limiting a maximum voltage drop of the first switch;
a second resistor connected between the DC output terminal and the gate of the third MOSFET;
a second diode connected in parallel to the second resistor, clamping a voltage drop of the second resistor;
a second switch switched by the second control signal to determine the third control signal; and
a second depletion-type MOSFET connected between the gate of the third MOSFET and the second switch, limiting a maximum voltage drop of the second switch.
